(19) United States
(12) Patent Application Publication
(10) Pub. No.: US 2014/0125763 A1
(43) Pub. Date: May 8, 2014

(54) 3D LED OUTPUT DEVICE AND PROCESS FOR EMITTING 3D CONTENT OUTPUT FOR LARGE SCREEN APPLICATIONS AND WHICH IS VISIBLE WITHOUT 3D GLASSES

(71) Applicant: ROBERT NATHAN COHEN, RIVERSIDE, CA (US)

(72) Inventor: ROBERT NATHAN COHEN, RIVERSIDE, CA (US)

(21) Appl. No.: 14/073,133

(22) Filed: Nov. 6, 2013

Related U.S. Application Data
(60) Provisional application No. 61/723,579, filed on Nov. 7, 2012.

(51) Int. Cl. H04N 13/04; H04N 13/00

(52) U.S. Cl. CPC H04N 13/0402; H04N 13/0007
USPC 348/43

(57) ABSTRACT

Some embodiments of the invention include a novel process for emitting 3D content that is visible without 3D eye-wear. In some embodiments, the process utilizes a 3D LED output device which emits 3D content that is visible without 3D eye-wear. The 3D LED output device allows a 3D content signal to output to a large 3D LED screen allowing those viewing to see 3D content without the use of 3D eye-wear. The process for emitting 3D content that is displayed without the need for 3D eye-wear improves upon the currently existing options by providing higher brightness, higher resolution, higher clarity, 3D output without 3D glasses, and hologram pop-out effects without 3D glasses.

### CLAIM OF BENEFIT TO PRIOR APPLICATION

This application claims benefit to U.S. Provisional Patent Application 61/723,579, entitled “TV-3D LED which emits a Large Screen 3D No Glasses output,” filed Nov. 7, 2012. The U.S. Provisional Patent Application 61/723,579 is incorporated herein by reference.

### BACKGROUND

Embodiments of the invention described in this specification relate generally to three-dimensional content display, and more particularly, to three-dimensional content display that is visible without three-dimensional eye-wear.

Televisions, display screens, and video projectors are often able to display three-dimensional (hereinafter “3D”) video content that is viewable by a person who utilizes the appropriate three-dimensional viewing eye-wear. For instance, a person wearing a pair of Anaglyph (Red/Cyan) glasses, would be able to see 3D video content displayed on a television. To date, the only option for displaying 3D video or film content out on large LED screens is with the Anaglyph (Red/Cyan) glasses. However, the use of Anaglyph glasses is an approach which only offers a low quality viewing experience. In addition to being generally poor in quality, many people simply do not like to wear 3D eye-wear. Furthermore, some 3D eye-wear is costly, resulting in less widespread acceptance of 3D video content. This is problematic for video and film producers, consumers of video and film content, and manufacturers of televisions, display screen, and video projectors.

Thus, what is needed is a way to display 3D content visible without 3D eye-wear.

### BRIEF DESCRIPTION

Some embodiments of the invention include a novel process for emitting 3D content that is visible without 3D eye-wear. In some embodiments, the process utilizes a 3D LED output device which emits 3D content that is visible without 3D eye-wear. In some embodiments, the process receives a standard video signal comprising one of a conventional 2D signal and a conventional 3D signal. The process of some embodiments performs a set of operations to the received standard signal. The set of operations transform the standard signal into a particular 3D content signal that is associated with the 3D LED output device. In some embodiments, the 3D LED output device is one of a plurality of 3D LED output devices that are arranged on a large 3D LED display screen to allow the particular 3D content signal to be displayed on the screen without exterior projection and to be viewed without the use of 3D eye-wear.

In some embodiments, a system is provided for capturing a standard video signal, transforming the standard video signal into a particular 3D content signal, and outputting the particular 3D content signal to a large 3D LED display screen suitable for displaying the particular 3D content signal for viewing without 3D eye-wear. In some embodiments, the system comprises a content signal source device, a content signal transforming computing device, and a large 3D LED display panel. In some embodiments, the content signal source device provides a standard content source signal to the content signal transforming computing device. The standard content source signal comprises one of a conventional 2D signal format and a conventional 3D signal format. In some embodiments, the content signal transforming computing device comprises a software application that transforms the standard content source signal into a particular 3D content signal that is able to be emitted for display on the 3D LED display screen. In some embodiments, the 3D LED display screen comprises a plurality of 3D LED output devices that emit the particular 3D content signal to display 3D content that is visible to a viewer without 3D eye-wear.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a perspective view of a 3D LED output device which emits 3D content that is visible without 3D eye-wear in some embodiments.

FIG. 2 conceptually illustrates a side view of a 3D LED output device which emits 3D content that is visible without 3D eye-wear in some embodiments.

FIG. 3 conceptually illustrates another side view of a 3D LED output device which emits 3D content that is visible without 3D eye-wear in some embodiments.

FIG. 4 conceptually illustrates a bottom view of a 3D LED output device which emits 3D content that is visible without 3D eye-wear in some embodiments.

FIG. 5 conceptually illustrates a top view of a 3D LED output device which emits 3D content that is visible without 3D eye-wear in some embodiments.

FIG. 6 conceptually illustrates a front view of a flex panel display screen that display 3D content which is visible without 3D eye-wear in some embodiments.

FIG. 7 conceptually illustrates a schematic view of a 3D LED output system capable of displaying 3D content which is visible without 3D eye-wear in some embodiments.

FIG. 8 conceptually conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

To date, the existing options to watch 3D content play out on large screens are limited to (1) anaglyphic display (Red/Cyan) with glasses, (2) projection display (Non-LED) with glasses, and (3) rear projection display (lenticular) which is generally of poor quality. As stated above, these approaches to displaying 3D content provide low quality viewing experiences.

Embodiments of the invention described in this specification solve such problems by emitting 3D content that is visible without 3D eye-wear. In some embodiments, 3D LED output devices emit 3D content without projection and which is visible without 3D eye-wear. The 3D LED output devices allows a 3D content signal to be displayed on a large 3D LED screen, thereby permitting viewers to see 3D content without the use of 3D eye-wear.

Specifically, some embodiments of the invention provide a novel process for emitting 3D content that is visible without 3D eye-wear. In some embodiments, the process utilizes a 3D LED output device which emits 3D content that is visible without 3D eye-wear. In some embodiments, the process receives a standard video signal comprising one of a conventional 2D signal and a conventional 3D signal. The process of some embodiments performs a set of operations to the received standard signal. The set of operations transform the standard signal into a particular 3D content signal that is associated with the 3D LED output device. In some embodiments, the 3D LED output device is one of a plurality of 3D LED output devices that are arranged on a large 3D LED display screen to allow the particular 3D content signal to be displayed on the screen without exterior projection and to be viewed without the use of 3D eye-wear.

Some embodiments of the process for emitting 3D content that is visible without 3D eye-wear differ from and improve upon currently existing options. In particular, some embodiments differ by providing 3D output without the need to wear 3D glasses. In contrast, all of the large screen options to date use LED output only in 2D output viewing format. Thus, by allowing large screen viewers to watch 2D or 3D without the need for 3D glasses, the process for emitting 3D output via the 3D LED output device provides a different viewing experience for a viewer. In addition, these embodiments improve upon the currently existing options by providing higher brightness, higher resolution, higher clarity, 3D output without 3D glasses, and hologram pop-out effects without 3D glasses.

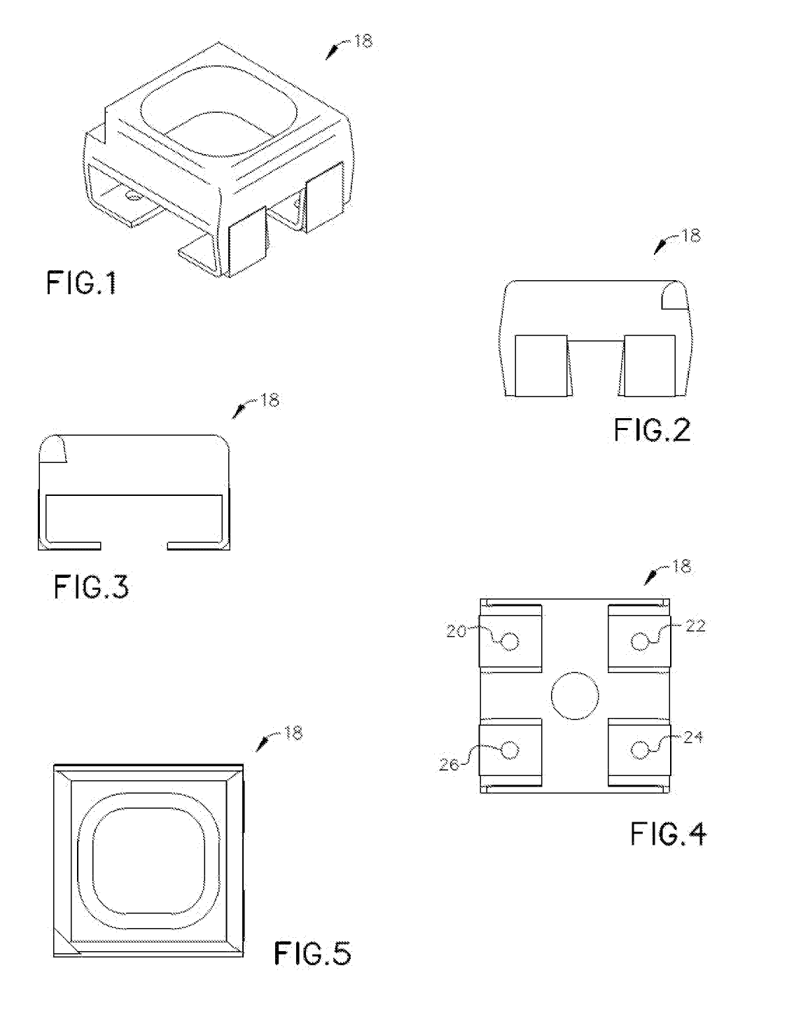

By way of example, FIGS. 1-5 conceptually illustrate several views of a 3D LED output device which emits 3D content that is visible without 3D eye-wear in some embodiments. Specifically, these figures show a TV 3D LED output device 18 in perspective view (i.e., FIG. 1) and, two different side views (i.e., FIGS. 2 and 3), top view (i.e., FIG. 5), and bottom view (i.e., FIG. 4). Also, the bottom view of the TV 3D LED output device 18 shown in FIG. 4 further illustrates a plurality of cathodes 20, 22, and 24, and an anode 26. In some embodiments, the TV 3D LED output device 18 comprises a blue cathode 20, a green cathode 22, a red cathode 24, and a common anode 26.

In some embodiments, a system is provided for capturing a standard video signal, transforming the standard video signal into a particular 3D content signal, and outputting the particular 3D content signal to a large 3D LED display screen suitable for displaying the particular 3D content signal for viewing without 3D eye-wear. In some embodiments, the system comprises a content signal source device, a content signal transforming computing device, and a large 3D LED display panel. In some embodiments, the content signal source device provides a standard content source signal to the content signal transforming computing device. The standard content source signal comprises one of a conventional 2D signal format and a conventional 3D signal format. In some embodiments, the content signal transforming computing device comprises a software application that transforms the standard content source signal into a particular 3D content signal that is able to be emitted for display on the 3D LED display screen. In some embodiments, the 3D LED display screen comprises a plurality of 3D LED output devices that emit the particular 3D content signal to display 3D content that is visible to a viewer without 3D eye-wear.

The process for emitting 3D content without needing 3D eye-wear of the present disclosure generally works by utilizing the 3D LED output devices of the system as the final point of three proprietary stages. The final TV-3D signal is correctly output to the 3D LED output devices into a 3D no glasses viewing experience for large screen application.

The process for emitting 3D content that can be displayed without the need of 3D eye-wear is made up of three separate parts in some embodiments. Specifically, when placed in alignment with each other, the end result is the ability to watch 3D content without the need for glasses on large screens used for entertainment, advertising, and other viewing experiences.

This process of some embodiments works best if the 3D content is first captured on a specific 3D camera designed to format content for final display via the 3D LED output devices. However, standard 2D and 3D content signals can be captured and transformed into proprietary 3D content signals that are suitable for display with the 3D LED content system described above. In some embodiments, the process transforms the captured standard content signal by transmitting the captured content signal from a content capture device, such as a video camera, to a computing device that stores a computer application for making a set of adjustments to the content data, and then outputting the transformed proprietary 3D signal to a set of 3D LED output devices that are deployed on one of a flex display screen and a flat display screen. Also, the flex display screen in some embodiments of the 3D LED content display system is flexible and can be secured to a curved surfaces. In some embodiments, a plurality of the flex display screen panels can be secured to a curved surface adjacent to each other, such that a very large curved surface can be covered by the flex display screens. For example, a half dome or rotunda could be completely covered with adjacently secured flex display screen panels, thereby allowing 3D content to be displayed over the entire dome or rotunda, without the need of any content projections and without the need of 3D vision eye-wear to view the 3D content.

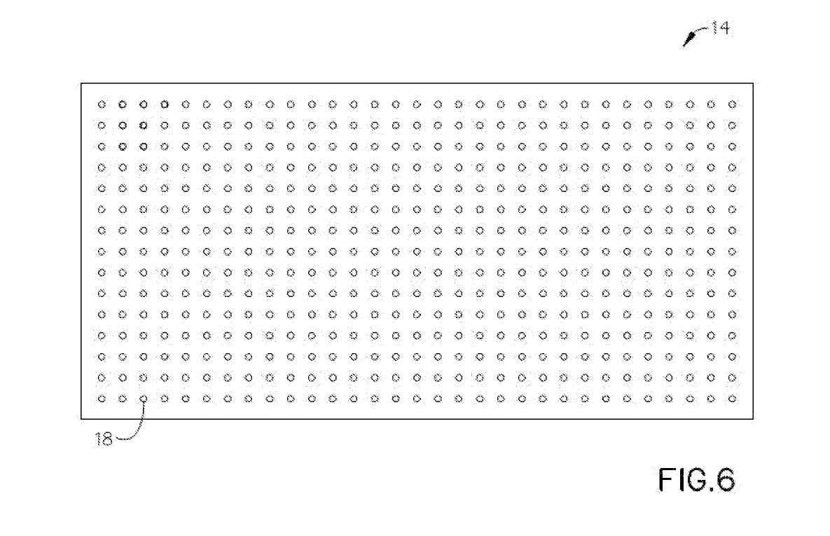

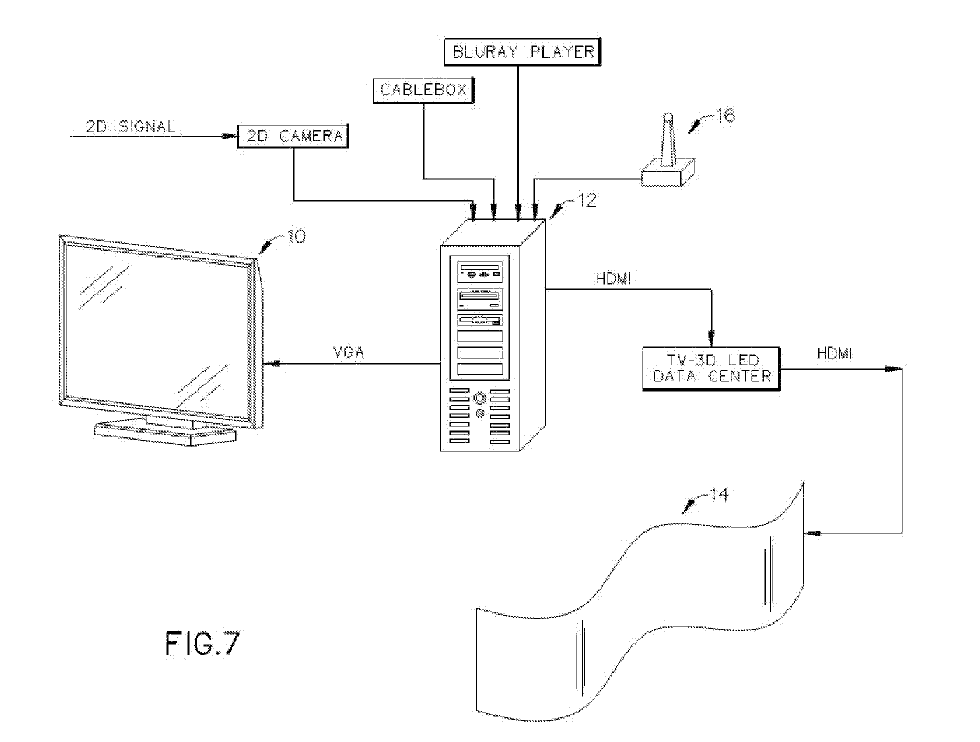

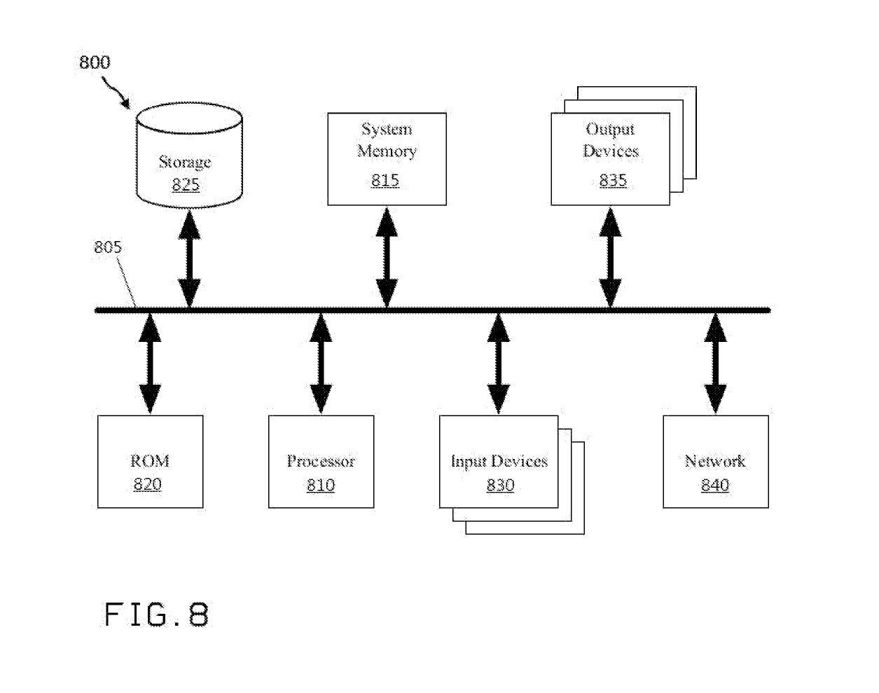

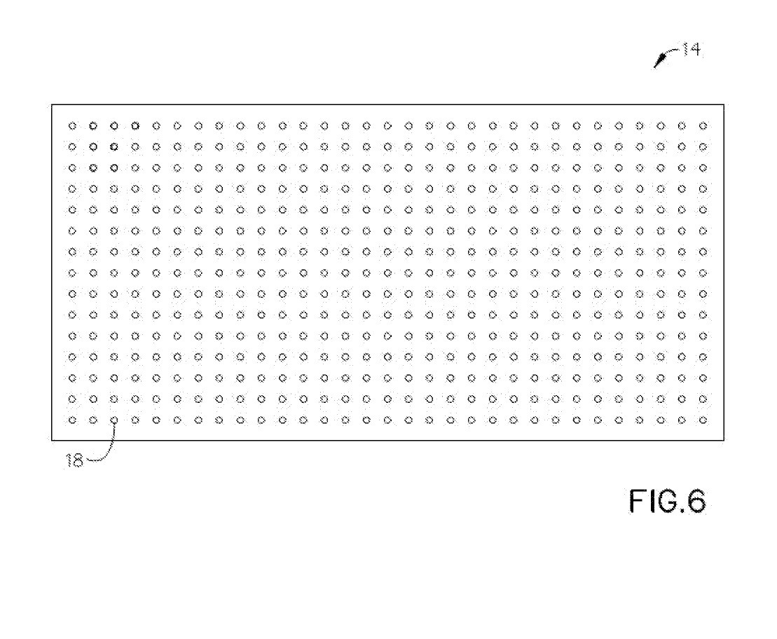

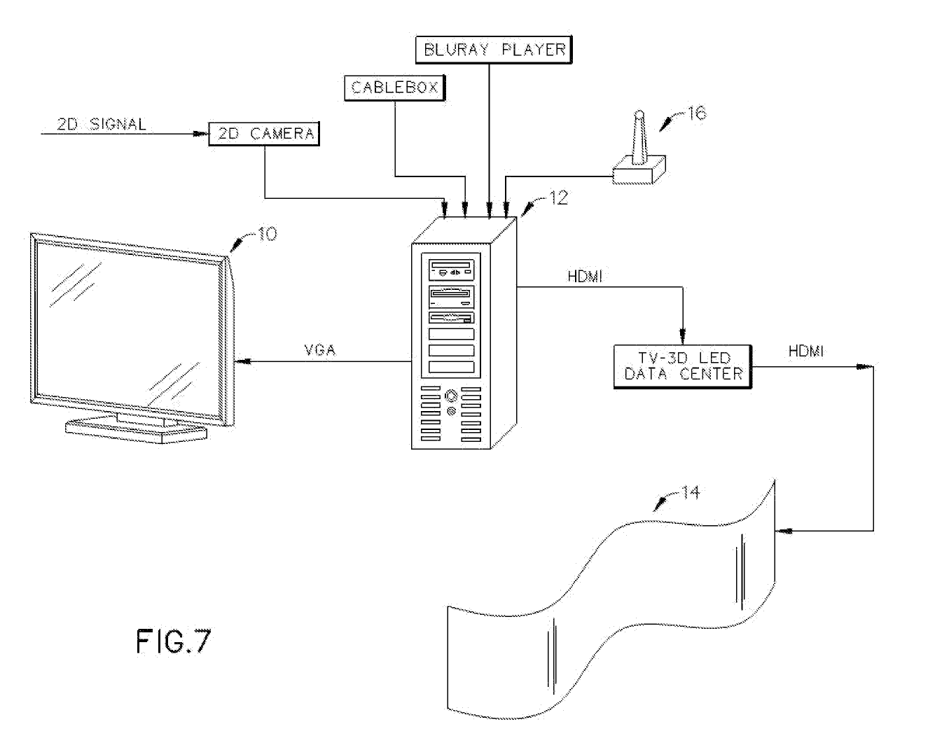

By way of example, FIG. 6 conceptually illustrates a front view of a flex panel wall 14 that supports multiple TV 3D LED output devices 18 to display 3D content which is visible without 3D eye-wear in some embodiments. Although the flex panel wall 14 in this example appears rectangular, the panel is flexible enough to be secured to any curved surface. This flexible surface mounting of the flex panel wall 14 is further described by reference to FIG. 7, below.

In some embodiments, the software application, when running on the processing unit of the computing device, receives captured content signals comprising one or more of 2D, 3D, non-HD, HD, and Ultra-HD content signals. In some embodiments, the captured content signals are processed by the software application when running on a processing unit of the computing device. The captured content signals are transformed into the resulting 3D LED content signals that are capable of being emitted by the 3D LED output devices 18 arranged on the flex panel wall 14. The resulting 3D content is then transmitted to the 3D LED output devices 18 for display in 3D. The final viewing experience allows large screen viewing of 3D without the need for glasses.

FIG. 7 conceptually illustrates a schematic view of a 3D LED output system capable of displaying 3D content which is visible without 3D eye-wear in some embodiments. As shown in this figure, a TV 3D control computing device 12 receives content input from a variety of content sources. The content sources of some embodiments can be any source capable of producing 3D content for processing with this system. In particular, in this example, the 3D LED output system includes a 2D camera device, a cable box device, a Blu-Ray player device, and a live streaming content device 16, each transmitting a 3D content stream to the TV 3D control computing device 12.

Once received by the TV 3D control computing device 12, the software application running on the processing unit of the TV 3D control computing device 12 begins to process the source content for enhanced 3D display in a manner that a person viewing a display panel 14 would not need to wear 3D eye-wear to view the 3D content. After processing is completed by the software application, the TV 3D control computing device 12 outputs the resulting 3D signal to one or both of the 2D/3D display screen 10 (via VGA signal) and the TV 3D LED data center (via HDMI signal) for pass through to the display panel 14.

To make the 3D LED output devices for emitting 3D content of the present disclosure, a person would need to select an appropriate 2D LED, in which the 2D LED satisfies a minimum threshold output performance. The person would then need to design a correct 3D-LED Lens based on the size and specs of the selected 2D LED, in which the 3D Lens is placed in front of the 2D LED. Then the software would need to be adjusted to match the desired 3D Lens pattern. Once adjusted, or tuned in, the LED is would be ready for installation. A series of the 3D LED output devices could then be installed on tiles in groups in correct alignment. For instance, a two-dimensional array pattern of the 3D LED output devices could be deployed. The 3D LED output devices could then be installed onto the desired tiles based on usage. The 3D LED tiles would then be installed side by side to achieve the desired large screen output area. Once the TV-3D LED screen is completed, then the 3D content signal could to be sent in. As noted above, the 3D content signal would be the 3D content following a set of steps for processing the captured content and generating the 3D content signal by the software application running on the computing device. The final output signal will need to adjusted and set prior to performing correct TV-3D no glasses output.

Although the elements described above are included in some embodiments, the set of necessary elements include only (i) correct 2D LED (meets requirements), (ii) correct 3D LENs (fit to size & specs), and (iii) correct TV-3D signal (TV-3D signal). A number of optional elements could be added to improve performance and viewing experience. Some of the optional elements include (i) a better performing 2D LED, (ii) a longer lasting 2D LED, (iii) a smaller 2D LED, (iv) a more durable 3D LENs, (v) a higher resolution 2D LED, (vi) a lower cost 2D LED, (vii) a lower cost 3D LED Lens.

To perform an identical function there needs to be 3 components, including (1) a correct 2D LED, (2) a correct 3D Lens, and (3) a correct 3D signal. To perform a similar function one could project 2D from behind a 3D lens, by providing a low light environment with limited viewing angles and lower quality output. Also, one could play an Anaglyph 3D signal through 2D LEDs, but the viewer would need to wear Anaglyph glasses, and the quality would be general poor.

To use the 3D LED output devices of the present disclosure, a person could install multiple 3D LED output devices in a two-dimensional array across a large screen area. For instance, the 3D LED output devices could be laid out in flex or flat tile approach over existing theater screens allowing with a TV-3D no glasses output.

Additionally, a person could install the 3D LED output devices onto a dome inner lining using a flex tile approach to a partial, or full interior covering allowing for a TV-3D no glasses output viewing experience. The person could also apply 3D LED output devices to a billboard, or to large advertising signage for application of 3D No Glasses output. The military could install 3D LED output devices to the interior of a training environment to simulate many different training scenes. Performance stages could install 3D LED output devices on large background surfaces to allow almost never-ending 3D no glasses images and settings to match the desired show themes. Amusement park rides could install 3D LED output devices in place of the current I-max Projection screens for a brighter, more lifelike 3D experience without the need for glasses. All I-MAX and Real-D Theaters can install the 3D LED output devices over the current projection theater screens and eliminate the need for projection. This would result in no more need for projectors or film reels, as all of the content would be digital. In this way, the 3D LED output devices, when deployed on a display panel, allow a brighter, cleaner, 2D and 3D viewing experience without the need for glasses. Additionally, because the 3D LED output devices are the final output point at which the desired 3D content is displayed (without the need for 3D eye-wear), the output experience can be applied to many applications in many fields of technology. Examples of adapted uses include large computer gaming environments, large environments with large wall surfaces, entertainment arenas, and live band or concert environments.

Also, it can produce a variety of final assembly products and devices once it is put in place as a sub assembly. The following list of products and devices is intended to be exemplary only and it is not intended that this list be used to limit the types of final assembly products and devices that can be produced. Persons having ordinary skill in the art relevant to the present disclosure may understand there to be equivalent products and devices that may be substituted within the present disclosure without changing their essential function or operation.

Large screen display systems

Large screen Theater systems

Large screen Dome systems

Large Screen Billboard systems

Large Screen Training environments

Large screen Home theaters

Large screen Amusement park rides

Large screen Trade show booths

Large screen Movie theater upgrade

Large screen Real-D Theater upgrade

Large screen I-Max Theater upgrade

Large screen military training system

Large screen special effects machine

Large area dance floors

Large area Holo-deck rooms

Large area exterior finishes

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

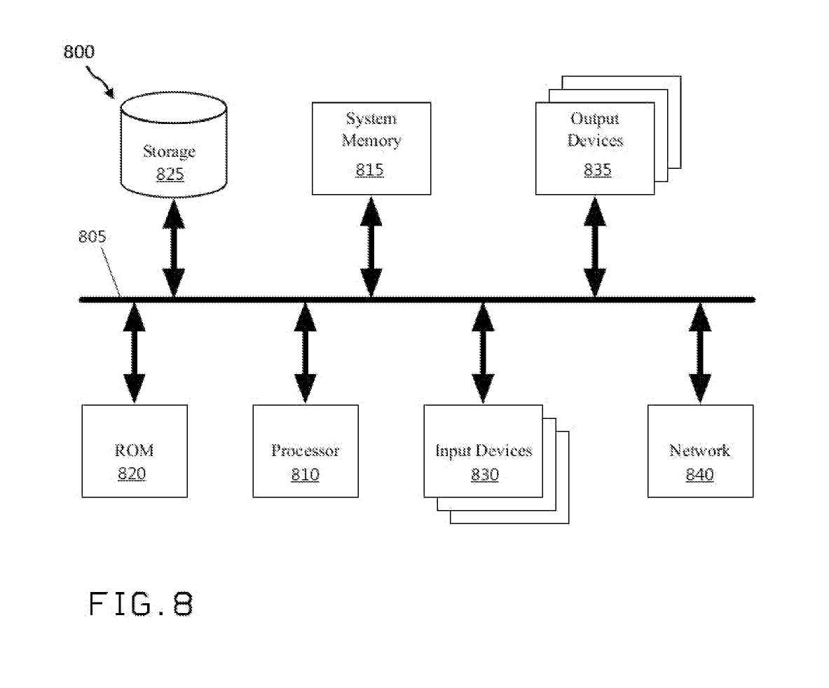

FIG. 8 conceptually illustrates an electronic system 800 with which some embodiments of the invention are implemented. The electronic system 800 may be a computer, phone, PDA, or any other sort of electronic device. Such an electronic system includes various types of computer readable media and interfaces for various other types of computer readable media. Electronic system 800 includes a bus 805, processing unit(s) 810, a system memory 815, a read-only 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only 820. For example, the various memory units include instructions for processing appearance alterations of displayable characters in accordance with some embodiments. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800. The output devices 835 include printers and display devices, such as cathode ray tubes (CRT) or liquid crystal displays (LCD). Some embodiments include devices such as a touchscreen that functions as both input and output devices.

Finally, as shown in FIG. 8, bus 805 also couples electronic system 800 to a network 840 through a network adapter (not shown). In this manner, the computer can be a part of a network of computers (such as a local area network (“LAN”), a wide area network (“WAN”), or an Intranet), or a network of networks (such as the Internet). Any or all components of electronic system 800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the figures illustrate example 3D LED output devices. However, a variety of design forms and shapes could be utilized for the 3D LED output devices. Thus, one of ordinary skill in the art would understand that the invention is not to be limited by the foregoing illustrative details and examples, but rather is to be defined by the appended claims. Additionally, the dimensions, sizes, layouts, and configurations of flex and flat panel displays are not limited in any way by the foregoing details and examples, but are instead understood to include any dimensions, sizes, layouts, and configurations.

I claim:

1. A method for displaying 3D content signals that are visible without 3D eye-wear, said method comprising:
receiving a content signal from a content source device;
transforming the received content signal from a native signal format into a particular 3D signal format that is suitable for display on a large 3D LED display panel comprising a plurality of 3D LED output devices that emit the transformed content signal;
transmitting the transformed 3D content signal to the large 3D LED display panel; and
emitting the transformed 3D content signal out of the plurality of 3D LED output devices to display 3D content from the transformed 3D content signal, wherein said displayed 3D content is visible without the use of 3D eye-wear.

2. The method of claim 1, wherein the content signal is received by a computing device from a content capture device.

3. The method of claim 2, wherein the content capture device is a content capture camera that captures a conventional content signal comprising at least one of a conventional 2D content signal and a conventional 3D content signal.

4. The method of claim 2, wherein the computing device transforms the received content signal from a standard content signal comprising one of a standard 2D content signal and a standard 3D content signal to a specialized 3D content signal that is capable of being emitted out of a 3D LED output device.

5. A 3D LED output device that emits a 3D content signal to display 3D content that is visible by a viewer without 3D eye-wear, said 3D LED output device comprising:
a blue cathode;
a green cathode;
a red cathode; and
a common anode.

6. The 3D LED output device of claim 5 further comprising a display side that emits the 3D content when each of the blue cathode, the green cathode, and the red cathode receive part of the 3D content signal.

7. A 3D LED content display system that captures a standard video signal, transforms the standard video signal into a particular 3D content signal, and outputs the particular 3D content signal to display 3D content that is visible to a viewer without 3D eye-wear, the system comprising:
a content signal source device that provides a standard content source signal to be transformed for display in the particular 3D content format;
a content signal transforming computing device that receives the standard content source signal from the content signal source device and transforms the standard content source signal into the particular 3D content signal, and
a large 3D LED display panel that receives the particular 3D content signal from the content signal transforming computing device and displays the 3D content for viewing by a viewer without 3D eye-wear.

8. The 3D LED content display system of claim 7, wherein the large 3D LED display panel is a flexible 3D LED display that is secured to a large curved surface.

9. The 3D LED content display system of claim 8 further comprising a plurality of adjacently placed 3D LED flex display panels that are secured to the large curved surface.

10. The 3D LED content display system of claim 9, wherein the large curved surface is a dome and the plurality of adjacently placed 3D LED flex display panels secured to the large curved surface cover the entire inner surface of the dome.

11. The 3D LED content display system of claim 7, wherein the large 3D LED display panel is a flat 3D LED display panel that is secured to large flat surface.

12. The 3D LED content display system of claim 11 further comprising a plurality of adjacently placed 3D LED flat display panels that are secured to the large flat surface.

13. The 3D LED content display system of claim 12, wherein the large flat surface is a large vehicle side panel and the plurality of adjacently placed 3D LED flat display panels secured to the large flat surface cover the entire outer surface of the vehicle side panel.

14. The 3D LED content display system of claim 7, wherein the large 3D LED display panel comprises a plurality of 3D LED output devices arranged on a display side of the 3D LED display panel to emit the particular 3D content signal.

15. The 3D LED content display system of claim 7, wherein the content signal transforming computing device comprises a processor and a storage device, said storage device storing a software application which when running the processor performs a set of transformation operations on the received standard content source signal to generate the particular 3D content signal.
